(19) United States
(12) Patent Application Publication
(10) Pub. No.: US 2008/0133292 A1
(43) Pub. Date: Jun. 5, 2008

(54) Network-Based Delivery Of Technical Service To Automotive Manufacturers

(76) Inventors: Korey L. Opland, Minneapolis, MN (US); Alyssa A. Purdy, Saint Paul, MN (US)

Correspondence Address: 3M INNOVATIVE PROPERTIES COMPANY, PO BOX 33427, ST. PAUL, MN, 55133-3427, US

(21) Appl. No.: 11/720,167

(22) PCT Filed: Dec. 2, 2005
(86) PCT No.: PCT/US05/43569

§ 371 Date: May 24, 2007

Related U.S. Application Data
(60) Provisional application No. 60/632,700, filed on Dec. 2, 2004.

(51) Int. Cl. G06F 17/30; G06G 7/48

(52) U.S. Cl. 705/7

(57) ABSTRACT

A network-based technical service delivery (TSD) system delivers technical service for automotive components. The system includes a customer interface module for network-based communication with a client device associated with a manufacturer of an automotive product, and a service technician interface module for network-based communication with a client device associated with a service technician associated with a supplier of a component utilized by the manufacturer to produce the automotive product. A technical service media repository stores electronic technical service information related to the utilization of the component in the automotive product. The service technician interface module presents an interface by which the service technician uploads electronic technical service information to the technical service media repository. The customer interface module presents an interface by which the manufacturer remotely accesses the technical service information, and selectively retrieves the technical service information based on a specific manufacturing issue experienced by manufacturer.

### TECHNICAL FIELD

The invention relates to technical service for automotive manufacturers and, in particular, computer-based techniques for providing technical service to the automotive manufacturers.

### BACKGROUND

A supplier within the automotive industry typically provides automotive components, such as industrial-grade adhesive tape, to many different automotive manufacturers for use in manufacturing products. The manufacturers often utilize the components in various plants throughout the world where the products are assembled. A supplier of the automotive components typically provides significant training and technical service to the automotive manufacturer for troubleshooting purposes.

Due to the complexity of the manufacturing process, the automotive manufacturers often request, or require, that the supplier provide “hands-on” technical service, i.e., technical service conducted at the remote manufacturing locations on the actual products being manufactured. It may be desirable to the automotive manufacturers, for example, to have service technicians for the automotive suppliers demonstrate use of the supplied component on the actual product being manufactured, and to troubleshoot the use of the supplied component within the “live” manufacturing line.

Consequently, service technicians (also referred to technical service engineers) for the automotive suppliers are frequently asked to travel to locations throughout the world, resulting in considerable travel and expense. Moreover, the requirement of hands-on technical service may result in significant delay in providing technical service in response to a specific manufacturing issue due to travel time, and the potential that all qualified service technicians may be booked traveling to other manufacturers.

### SUMMARY

In general, the invention provides a network-based technical service delivery (TSD) system for hosting and delivering technical service for automotive components. Among other features, the TSD system provides real-time troubleshooting features that allow a service technician of an automotive supplier to address and solve manufacturing issues related to an automotive component.

The TSD system allows the service technician to remotely provide service and troubleshoot specific manufacturing issues without requiring the service technician to travel to the remote manufacturer. For example, upon experiencing a manufacturing issue, a user associated with the automotive manufacturer may access the TSD system and provides data generally describing the manufacturing issue. The user may also physically demonstrate the manufacturing issue on an actual manufactured product using a live manufacturing line, and utilize audio and video equipment to capture the demonstration and upload the demonstration to the TSD system.

Similarly, a service technician may capture specific multimedia that instructs the automotive manufacturers on the resolution of the issue. During this process, the service technician may perform instructional operations on a working product located at the supplier, capture the instructional operation using audio and video equipment, and upload the captured instructional multimedia to the TSD system for remote delivery to automotive manufacturers. The remote customer may view the recorded technical service information interactively with the service technician.

In this manner, the TSD system provides hosting and delivering features for technical service that is specific to issues experienced by one or more of automotive manufacturers. The system hosts the technical service information, and delivers the specific technical service information to the manufacturers either in real-time (i.e., substantially as provided by the service technician) or at a subsequent time.

The TSD system securely organizes data recording the manufacturing issue and the corresponding multimedia to ensure that a given one of automotive manufacturers cannot access data and multimedia associated with manufacturing issues experienced by other automotive manufacturers. In this manner, the TSD system provides a secure network repository for delivery issue-specific electronic technical service information for different automotive manufacturers.

In one embodiment, the invention is directed to a system for delivery of technical service for automotive components. The system comprises a customer interface module for network-based communication with a client device associated with a manufacturer of an automotive product, and a service technician interface module for network-based communication with a client device associated with a service technician associated with a supplier of a component utilized by the manufacturer to produce the automotive product. A technical service media repository stores electronic technical service information related to the utilization of the component in the automotive product. The service technician interface module presents an interface by which the service technician uploads electronic technical service information to the technical service media repository. The customer interface module presents an interface by which the manufacturer remotely accesses the technical service information, and selectively retrieves the technical service information based on a specific manufacturing issue experienced by manufacturer.

In another embodiment, the invention is directed to a method comprising presenting a service technician interface by which a service technician associated with a supplier of a component uploads electronic technical service information related to utilization of the component in an automotive product. The method further comprises storing the electronic technical service information in a network repository, and presenting a customer interface by which a manufacturer of the automotive product remotely accesses the technical service information and selectively retrieves the technical service information based on specific manufacturing issues experienced by manufacturer.

In another embodiment, the invention is directed to a computer-readable medium containing instructions. The instructions cause a programmable processor to present a service technician interface by which a service technician associated with a supplier of a component uploads electronic technical service information related to utilization of the component in an automotive product, and store the electronic technical service information in a network repository. The instructions further cause the programmable processor to index the technical service information in the network repository according to manufacturing issues experienced by the manufacturer, and present a customer interface by which a manufacturer of the automotive product remotely accesses the technical service information and selectively retrieves the technical service information according to the manufacturing issues.

The invention may provide one or more advantages. As one example, the TSD system may be utilized to provide real-time interaction between the service technician and the remote automotive manufacturer similar to the “hands-on” service often required. Moreover, the TSD system provides mechanisms for the efficient dissemination of up-to-date, issue-specific technical service information related to the use of a supplied component when manufacturing an end product. The TSD system provides organization and security levels to the information so that the customer (e.g., the manufacturer or other intermediate supplier) and their service technicians are able to access service information associated with their specific products and specific manufacturing issues.

The TSD system allows the automotive supplier to provide a high level of technical service at a reduced cost. For example, the TSD system may lead to reduced time, cost and overhead relative to conventional, hands-on service. Further, a supplier may be able to provide issue-specific troubleshooting with a much faster turnaround with the TSD system due to increased availability of technical service personnel. The TSD system may increase the availability of the most qualified service technicians, thereby increasing the overall quality of service provided by the automotive supplier. The TSD system may also allow the most qualified service technicians to utilize the best and most appropriate equipment, which is often located at the supplier and not at the manufacturer, when troubleshooting a problem.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary network environment in which a technical service delivery (TSD) system delivers electronic technical service information from a supplier to automotive manufacturers.

FIG. 2 is a block diagram illustrating a process of capturing and uploading multimedia to the TSD system.

FIG. 3 is a block diagram illustrating an exemplary embodiment of the TSD system of FIG. 1 in further detail.

FIGS. 4A and 4B are flowcharts that provide a high-level overview of example operation of the TSD system.

FIGS. 5-7 illustrate exemplary user interfaces presented by the TSD system.

### DETAILED DESCRIPTION

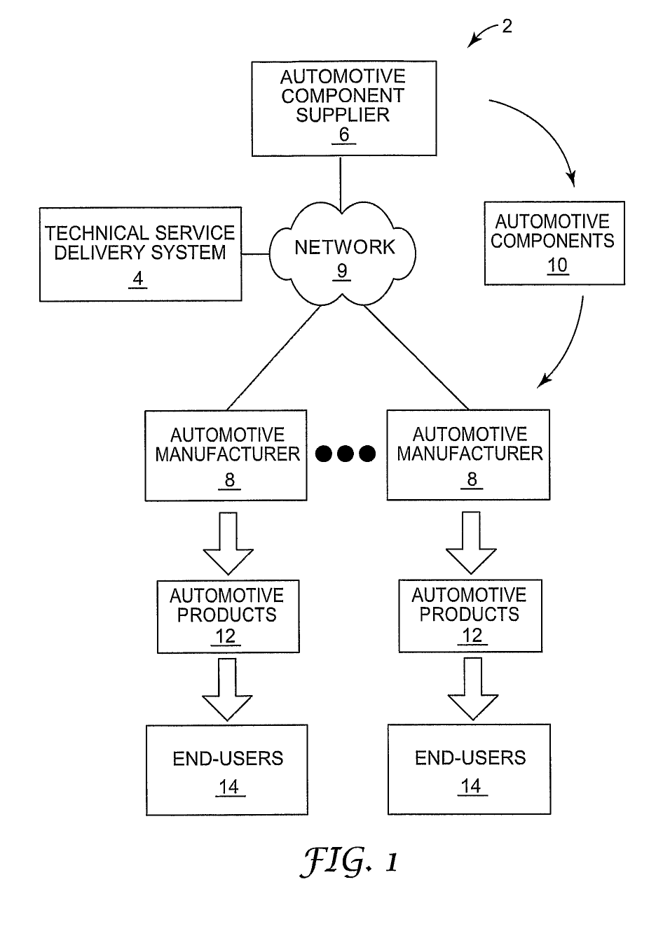

FIG. 1 is a block diagram illustrating a network environment 2 in which technical service delivery (TSD) system 4 provides a network resource by which automotive component supplier 6 delivers electronic technical service information to automotive manufacturers 8 to assist the manufacturers in resolving issues related to the use of components 10 when producing automotive products 12 to be delivered to end-users 14.

More specifically, service technicians associated with automotive component supplier 6 (“supplier 6”) interact with TSD system 4 via network 9 to provide technical service information in electronic form for specific manufacturing issues experienced by automotive manufacturers 8. Authorized users associated with automotive manufacturers 8 interact with TSD system 4 via network 9 to access the technical service information.

As described in further detail below, TSD system 4 includes one or more data servers for hosting and delivering the technical service information, e.g., via real-time multimedia streaming. Moreover, TSD system 4 allows service technicians of supplier 6 to upload technical service information that is specific to issues experienced by one or more of automotive manufacturers 8. TSD system 4 hosts the technical service information, and delivers the technical service information either in real-time (i.e., substantially as provided by the service technician) or at a subsequent time.

Examples of technical service information delivered by TSD system 4 include audio and video multimedia. Upon experiencing a manufacturing issue, a user associated with the automotive manufacturer 8 accesses TSD system 4 and provides data generally describing the manufacturing issue. The user may then physically demonstrate the manufacturing issue on one of products 12, which may be an actual product of a “live” manufacturing line. The user utilizes audio and video equipment to capture the demonstration. For example, the user may demonstrate a manufacturing problem that arises when adhesive tape (i.e., component 10) is utilized when producing automotives vehicles (i.e., products 12). The user may then upload the captured multimedia to TSD system 4 for remote delivery to a service technician associated with supplier 6.

Similarly, in response to a recorded manufacturing issue experienced by one or more of automotive manufacturers 8, a service technician may capture specific multimedia that instructs the automotive manufacturers on the resolution of the issue. During this process, the service technician may perform instructional operations on equipment located at supplier 6, and capture the instructional operation using audio and video equipment. The service technician may then upload the captured instructional multimedia to TSD system 4 for remote delivery to automotive manufacturers 8.

TSD system 4 securely organizes the data recording the manufacturing issue and the corresponding multimedia to ensure that a given one of automotive manufacturers 8 cannot access data and multimedia associated with manufacturing issues experienced by other automotive manufacturers. In this manner, TSD system 4 provides a secure network repository for delivery of issue-specific electronic technical service information to automotive manufacturers 8.

TSD system 4 may include a rules engine for automating the delivery of the technical service information to appropriate automotive manufacturers 8. For example, upon receiving technical service information from supplier 6 for a specific one of automotive manufacturers 8, TSD system 4 may automatically identify other automotive manufacturers that utilize the same components 10 to which the newly uploaded technical service information pertains. Upon identifying the automotive manufacturers 8, TSD system 4 may issue an electronic notification (e.g., an electronic mail message or alert associated with user accounts) to notify the automotive manufacturers that newly received technical service information for components 10 is available for viewing at the TSD system. In this manner, TSD system 4 provides a centralized intelligent system for ensuring that technical service information components 10 are timely delivered to the appropriate automotive manufacturers 8.

TSD system 4 includes a variety of features for application of business rules and other constraints to automate the delivery of technical service information to automotive manufacturers 8. For example, as described in detail below, TSD system 4 provides interfaces for the definition and management of rules, relationships, regulations, and other constraints to control the delivery of technical service information. Automotive manufacturers 8 may include any organization that utilizes components 10 when manufacturing automotive products 12 for sale to end-users 14.

Service technicians associated with supplier 6 and users associated with automotive manufacturers 8 typically interact with client computing devices suitable for communication and interaction with TSD system 4 via network 9. Examples of client computing devices include workstations, personal computers, laptop computers, or even network-enabled personal digital assistants (PDA), such as a Palm™ organizer from Palm Inc. of Santa Clara, Calif. or a Windows™ CE device. The client computing devices execute communication software, typically web browsers, such as Internet Explorer™ from Microsoft Corporation of Redmond, Wash., in order to communicate with TSD system 4. Network 9 represents any communication link suitable for communicating data, such as a wide-area network, local area network, or a global computer network like the World Wide Web.

One advantage that may be achieved by TSD system 4 is the ability to provide real-time interaction between service technicians and remote automotive manufacturers similar to the “hands-on” service often required. Moreover, TSD system 4 provides for the efficient dissemination of up-to-date, issue-specific technical service information related to the use of a supplied component 10 when used for manufacturing an end product 12.

TSD system 4 may allow supplier 6 to provide a high level of technical service at a reduced cost. For example, TSD system 4 may lead to reduced time, cost and overhead relative to conventional, hands-on service. Further, supplier 6 may be able to provide issue-specific troubleshooting with a much faster turnaround due to increased availability of technical service personnel. TSD system 4 may increase the availability of the most qualified service technicians, thereby increasing the overall quality of service provided by automotive supplier 4.

TSD system 4 may be offered to automotive manufacturers 8 as a value-add service in conjunction with the sale of components 10, such as adhesive automotive tape. Alternatively, TSD system 4 may charge automotive manufacturers 8 fees for use of the technical service information delivery services. TSD system 4 may, for example, charge data access fees based on the amount of electronic technical service information accessed by each of automotive manufacturers 8. TSD system 4 may also charge fees based on the number of recorded service “calls” logged and responded to by way of TSD system 4. Other examples, TSD system 4 may charge subscription service fees or time-based fees based on usage.

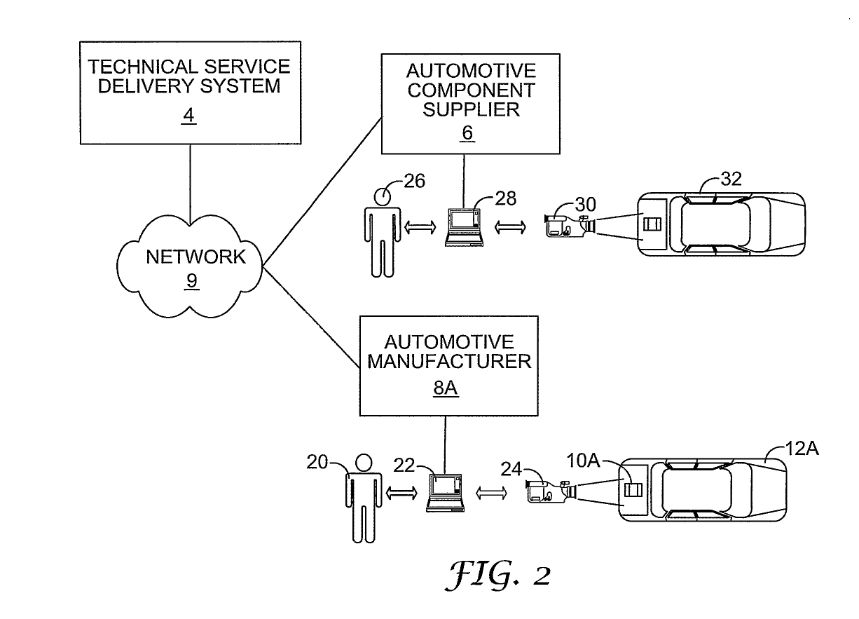

FIG. 2 is a block diagram illustrating in further detail the process of capturing and uploading media to TSD system 4. Upon experiencing a manufacturing issue, a user 20 associated with the automotive manufacturer 8A accesses TSD system 4. TSD system 4 presents an interface, e.g., a web-based interface, by which user 20 creates a new manufacturing issue entry, and inputs data generally describing the manufacturing issue. For example, user 20 may describe the date the manufacturing issue was detected, a manufacturing plant in which the issue was detected, and general information describing the issue. During this process, in the event supplier 6 provides a variety of components, user 20 specifies the particular type of component to which the issue relates. The interface presented by TSD system 4 may, for example, utilize a drop-down box or other input mechanism for this specification.

In response, TSD system 4 creates a data record to log the reported manufacturing issue. User 20 may then engage manufactured product 12A to physically demonstrate the manufacturing issue associated with component 10A. During this process, user 20 captures the demonstration with audio and video equipment 24. In this example, user 20 demonstrates a manufacturing problem that arises when an adhesive decal (i.e., component 10A in this example) is utilized when during the production of an automotive (i.e., product 12A). User 20 then interacts with client computing device 22 to capture audio and video multimedia from equipment 24, and upload the captured multimedia to TSD system 4 for remote delivery to service technician 26 associated with supplier 6.

Upon recording the entry for new manufacturing issue, TSD system 4 issues an electronic notification (e.g., an electronic mail message or an alert associated with a login account) to inform service technician 26. Service technician 26 reviews any multimedia uploaded by user 20. If service technician 26 is able to diagnose the manufacturing issue, the service technician may respond immediately to user 20 by way of TSD system 4. For example, service technician 26 may direct user 20 to previously uploaded technical service information already uploaded to TSD system 4, or may describe a potential solution by way of electronic message posted with TSD system 4.

In addition, service technician 26 may engage equipment 32 located at supplier 6 to demonstrate proper utilization of the component. During this process, service technician 26 may utilize audio and video equipment 30 to capture specific multimedia that instructs user 20 on the resolution of the manufacturing issue. Service technician 26 then interacts with client computing device 28 to upload the captured instructional multimedia to TSD system 4 for remote delivery to user 20 via network 9.

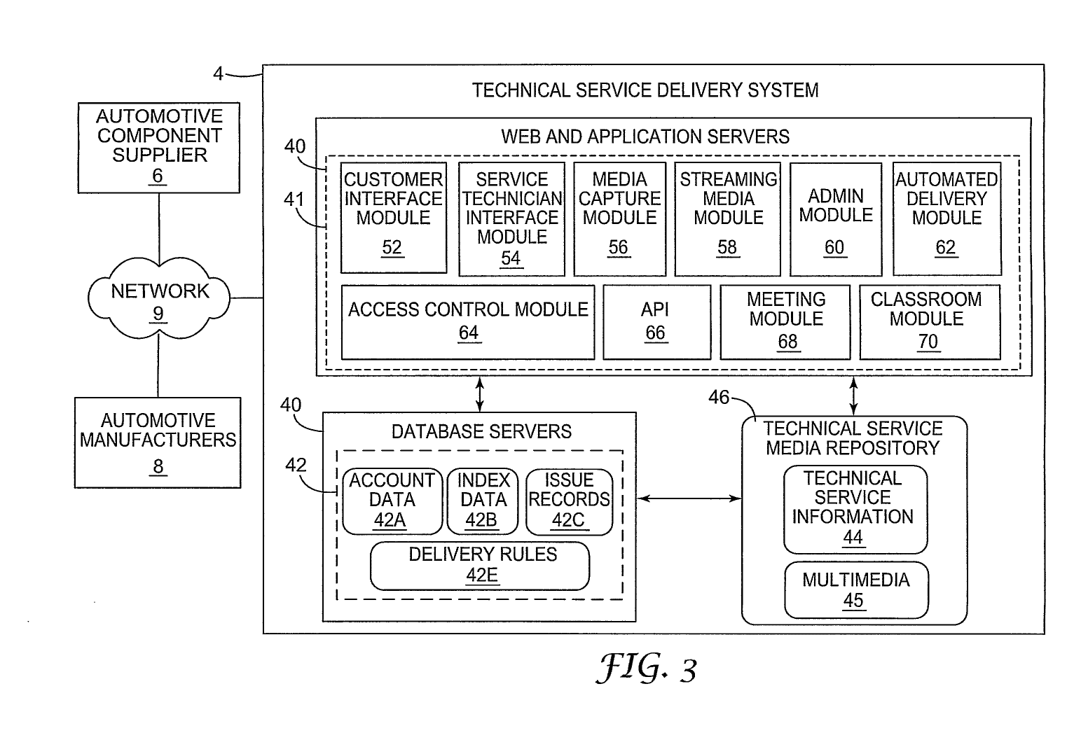

FIG. 3 is a block diagram illustrating an example embodiment of TSD system 4. In the example embodiment, web and application servers 40 provide an interface by which supplier 6 and automotive manufacturers 8 communicate with TSD system 4 via network 9. In one configuration, web and application servers execute web server software, such as Internet Information Server™ from Microsoft Corporation, of Redmond, Wash. As such, web and application servers 40 provide an environment for interacting with automotive manufacturers 8 according to software modules 41, which can include Active Server Pages, web pages written in hypertext markup language (HTML) or dynamic HTML, Active X modules, Lotus scripts, Java scripts, Java Applets, Distributed Component Object Modules (DCOM) and the like.

Although illustrated as “server side” software modules executing within an operating environment provided by web and application servers 40, software modules 41 could readily be implemented as “client-side” software modules executing on computing devices used by supplier 6 or automotive manufacturers 8. Software modules 41 could, for example, be implemented as Active X modules executed by web browsers or other software applications executing on the computing devices.

Software modules 41 include a number of modules including customer interface module 52, service technician interface module 54, media capture module 56, streaming media module 58, administration (“ADMIN” in FIG. 3) module 60 and automated delivery module 62. Software modules 41 interact with one or more database servers 40 to access data 42, which may include account data 42A, index data 42B, issue records 42C and delivery rules 42E. Data 42 may be stored in a variety of forms including data storage files, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Data 42 could, for example, be stored within a single relational database, such as SQL Server from Microsoft Corporation.

Account data 42A defines login information for authorized users of TSD system 4, including service technicians associated with supplier 6 and users associated with automotive manufacturers 8.

Index data 42B represents one or more indexes maintained by database servers 40 that provide identification and location information for particular technical service information 44 stored within technical service repository 46. Specifically, index data 42B allows authorized users of TSD system 4 to query and retrieve technical service information 44 and multimedia 45 based on specific manufacturing issues and/or components to which the technical service information relates.

Issue records 42C represent the recorded manufacturing issues and the related data provided by automotive manufacturers 8. Delivery rules 42E define a set of rules that control the automated identification of automotive manufacturers that utilize the components 10 that pertain to newly uploaded technical service information 44. Automated delivery module 62 utilizes delivery rules 42E to generate electronic notification (e.g., an electronic mail message or alert associated with user accounts) to notify the automotive manufacturers 8 that newly received technical service information 44 is available for viewing at TSD system 4.

Customer interface module 52 presents an interface by which automotive manufacturers 8 remotely access technical service information 44 stored in technical service repository 46. By interacting with the interface, automotive manufacturers 8 record new manufacturing errors, and issue queries to identify relevant technical service information 44. Consequently, customer interface module 52 allows automotive manufacturers 8 to selectively retrieve technical service information 44 based on specific manufacturing issues experienced by each of the manufacturers.

Service technician interface module 54 presents an interface by which the service technicians access TSD system 4. Specifically, upon entering appropriate account information, a service technician may view and construct messages for automotive manufacturers 8 with respect to specific manufacturing issues. In addition, the service technician may upload electronic technical service information 44, such as electronic documentation or functional specifications, to technical service media repository 46.

Media capture module 56 receives from automotive manufacturers 8 uploaded audio and video data that is related to specific manufacturing issues experienced by the manufacturers. Media capture module 56 directs database servers 40 to generate index data 42B to aid subsequent retrieval of the uploaded media, and stores the uploaded media within technical service media repository 46 as multimedia 45. Media capture module 56 may receive the uploaded media from automotive manufacturers 8 in the form of audio and video data that captures a demonstration of a manufacturing issue, or from supplier 6 that provides instruction on addressing the manufacturing issue.

Streaming media module 58 streams the uploaded multi-media content to the client devices associated with supplier 6 and automotive manufacturers 8. For example, streaming media module 58 may stream multimedia 45 to a client device associated with a service technician to present the audio and video data to the service technician for troubleshooting the specific manufacturing issue experienced by the manufacturer. As another example, streaming media module 58 may stream multimedia 45 to a client device associated automotive manufacturers 8 to present the audio and video data to instruct the manufacturer to resolve the specific manufacturing issue experienced by the manufacturer.

Administration (“ADMIN” in FIG. 3) module 60 presents an interface by which system administrators configure TSD system 4. A system administrator may, for example, manage accounts for automotive manufacturers 8 including setting access privileges, and define a number of corporate and user preferences. Administration module 60 allows the system administrator to define access rights for automotive manufacturers 8 to control the access to the various software modules 41. In this manner, not all users can access all of the software modules 41. For example, a system administrator may establish access rights to use by access control module 64 in providing secure access to portions of technical service media repository 46. Thus, access control module 64 ensures that a given one of automotive manufacturers 8 cannot access confidential data 42, technical service information 44 and multimedia 45 associated with manufacturing issues experienced by other automotive manufacturers.

In addition, a system administrator can interact with administration module 60 to define and maintain delivery rules 42 for controlling automated delivery of technical service information 44 and multimedia 45 to automotive manufacturers 8.

Application programming interface (API) 66 provides the ability to establish direct connections with external computing devices. API 66 may be used to allow external systems to communicate with TSD system 4 to automatically record manufacturing issues, or to automatically retrieve data from TSD system 4. For example, a front-end module, such as a script or command line interface provided by the remote computing system, for example, may communicate with API 66 directly, thereby bypassing the interfaces presented by other software modules 41. In this manner, the front-end module can automatically interact with TSD system 4 and control output. As a result, API 66 can be useful when connecting to internal corporate systems to incorporate, for example, product information and manufacturing records. For example, API 66 may be used at manufacturing time to automatically provide run-time information for manufacturing errors that may occur within automotive manufacturers 8. As a result, API 66 may facilitate the automatic delivery of technical service information to automotive manufacturers 8 upon receiving manufacturing error information via API 66, thereby substantially accelerating resolution of the manufacturing issue.

Meeting module 68 provides a private mechanism by which service technicians and users associated with automotive manufacturers may conduct online, real-time discussions. Classroom module 70 provides a real-time environment for scheduled training sessions having one or more service technicians and multiple users.

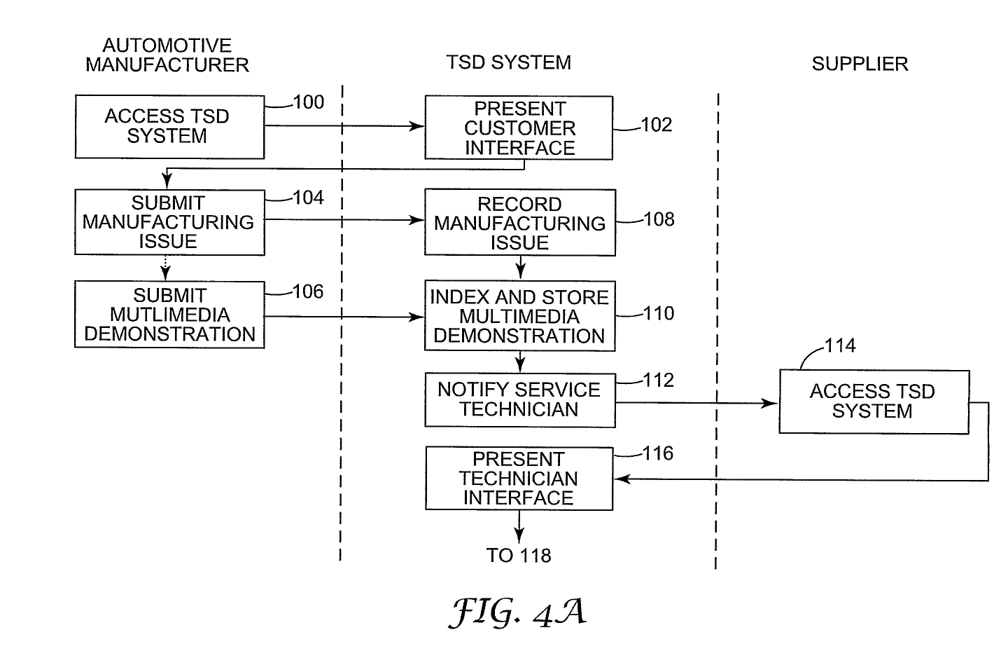

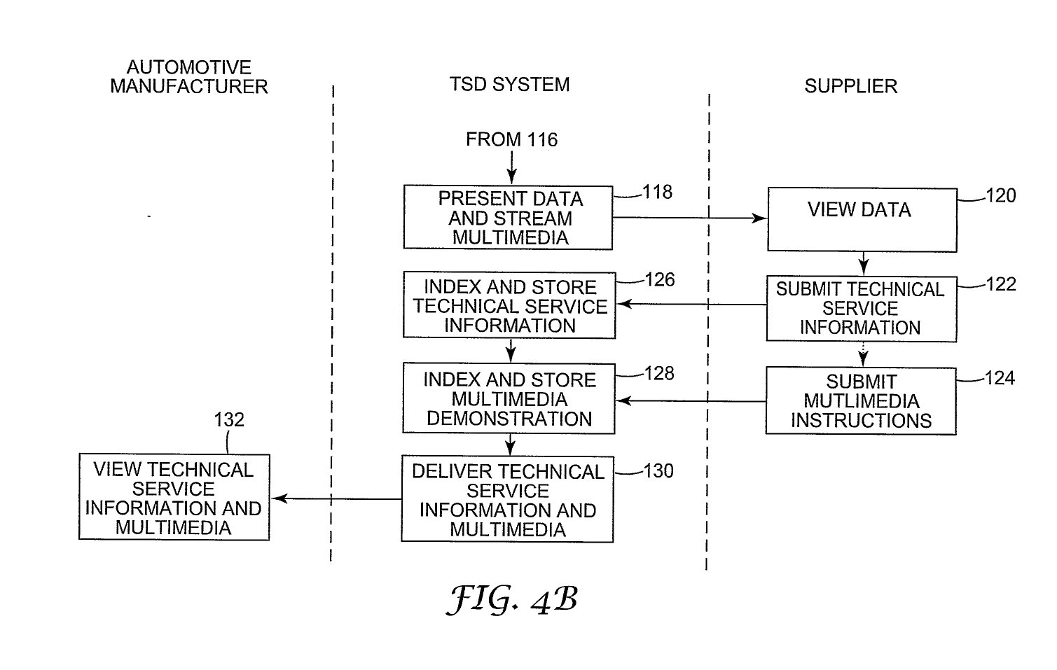

FIGS. 4A and 4B are flowcharts that provide a high-level overview of example operation of TSD system 4. Initially, a user associated with one of automotive manufacturers 8 accesses TSD system 4 (100), causing customer interface module 52 to present a web-based interface (102). During this process, the user submits user and authentication information, e.g., a password.

Once authorized, the user interacts with the customer interface to record new manufacturing issues (104). Alternatively, data describing the manufacturing issue may be communicated to TSD system 4 automatically via API 66. In either case, the user may record and upload a multimedia demonstration of manufacturing issue (106).

In response, customer interface module 52 of TSD system 4 updates issue records 42C to record the manufacturing issue (108), and indexes and stores any uploaded multimedia demonstration (110). Specifically, database servers 40 updates index data 42B to associate the uploaded multimedia demonstration with the newly created issue record 42C.

Service technician interface module 54 identifies a service technician assigned to the automotive manufacturer that created the error record, and issues a notification to the service technician (112). When the service technician accesses TSD system 4, service technician interface module 54 presents a web-based interface that authenticates the service technician (114). Once authenticated, the service technician may query index data 42B and retrieve relevant issue records 42C and corresponding multimedia 45 provided by the automotive manufacturer to demonstrate the issue (118, 120).

The service technician then submits issue-specific technical service information (122) and optionally uploads multimedia to instruct the particular client on resolution of the manufacturing issue (124). Upon receipt, technical service interface module 54 and indexes and stores any uploaded issue-specific technical service information and related instructional multimedia (126, 128) for delivery to the automotive manufacturer with which the error record is associated (130, 132). During this process, automated delivery module 62 may utilize delivery rules 42E to identify other automotive manufacturers 8 that utilize similar components, and generate electronic notifications to notify the manufacturers that newly received technical service information 44 is available for viewing at TSD system 4.

The process illustrated in FIGS. 4A and 4B may be repeated until resolution of the manufacturing issue. Either the service technician or the user associated with the automotive manufacturer may take the lead in capturing and uploading multimedia to facilitate resolution. Moreover, the service technician and the user may interactively view the uploaded multimedia to facilitate the resolution process.

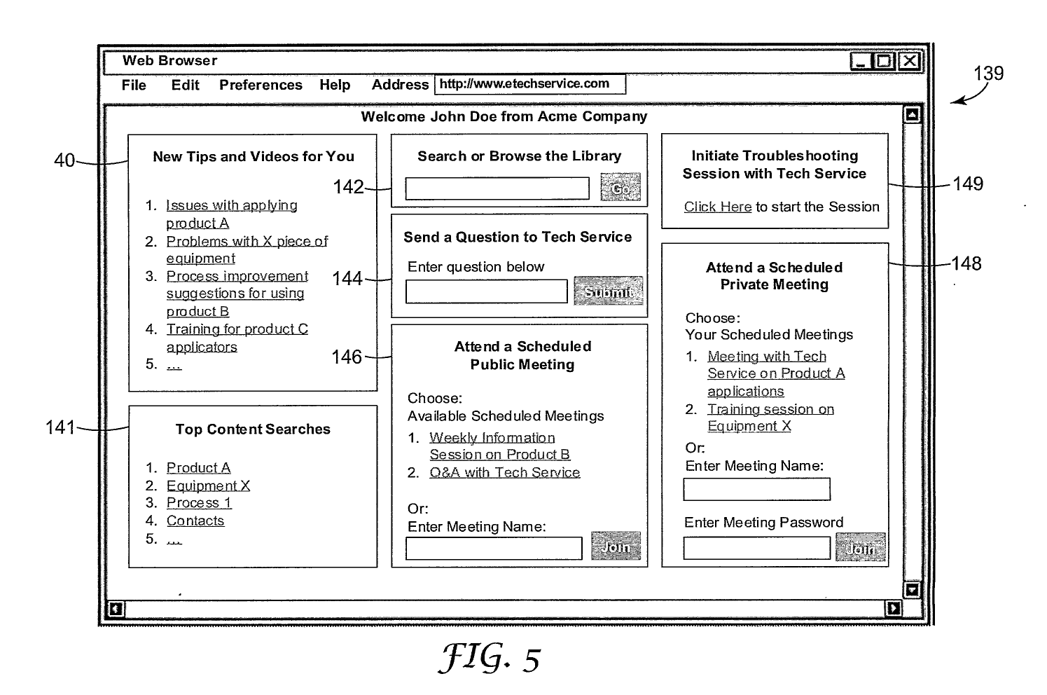

FIG. 5 illustrates an exemplary web-based user interface 139 presented by TSD system 4 when initially accessed by a user associated with an automotive manufacturer. As illustrated in FIG. 5, user interface 139 includes a tips window 140 by which TSD system 4 displays hypertext links for retrieving newly posted technical service information that relates to the specific products or manufacturing equipment used by the automotive manufacturer.

User interface 139 further includes window 141 which presents hypertext links for retrieving technical service information matching recent searches defined by the user. Window 142 includes an input mechanism for defining search terms for locating technical service information 44 and/or multimedia 45 located within the technical service media repository 46 maintained by TSD system 4. Window 144 includes an input mechanism by which the user may submit a technical service question for a specific manufacturing issue. Window 146 allows the user to search for and attend publicly scheduled technical service meetings. Window 148 allows the user to attend privately scheduled technical service meetings. Window 149 allows the user to record a specific manufacturing issue with a component, and initiate a troubleshooting session with a technician with respect to the issue.

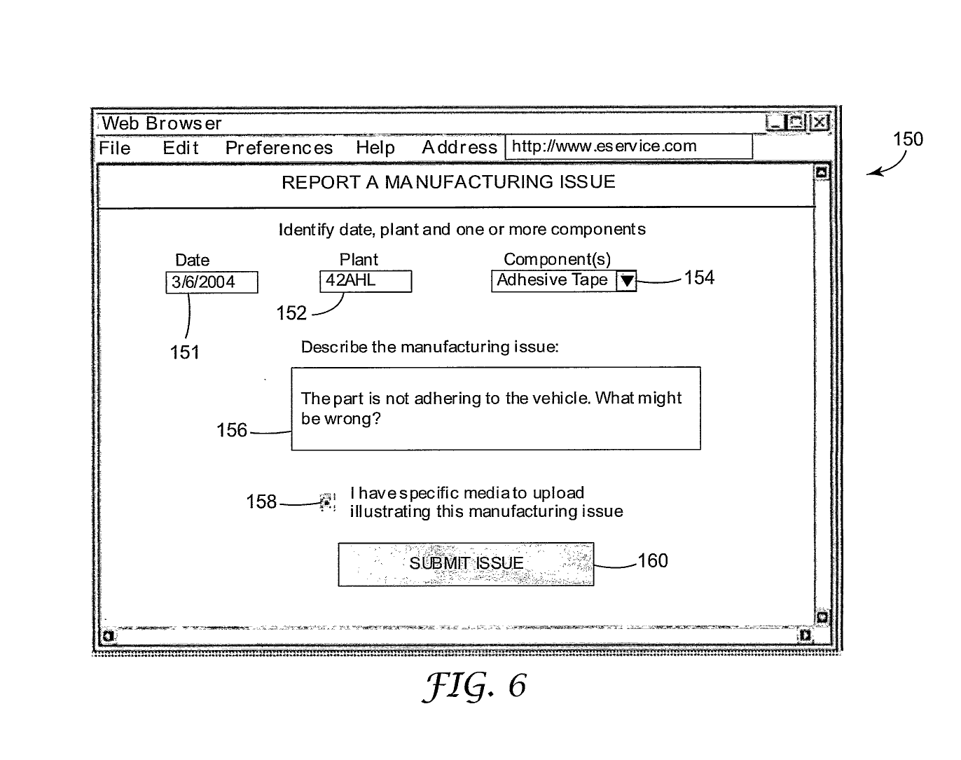

FIG. 6 illustrates an exemplary user interface 150 presented by customer interface module 52 of TSD system 4 when the user initiates a troubleshooting session. User interface 150 includes an input mechanism 151 by which the user specifies a date when the manufacturing issue arose. Input mechanism 152 allows the user to specify the manufacturing plant where the manufacturing issue arose. Input mechanism 154 is a drop-down menu of components purchased by the manufacturer, and the user identifies one or more of the components associated with the specific manufacturing issue. Input 156 provides a text box with which the user interacts to describe the manufacturing issue.

User interface 150 provides a checkbox 158 by which the user indicates whether specific multimedia has been captured that demonstrates the experienced manufacturing issue on an actual product. When the user selects SUBMIT ISSUE button 160, TSD system 4 prompts the user to upload the specific multimedia, and stores the multimedia within technical service repository 46 (FIG. 3). TSD system 4 creates a new one of issue records 42C, stores the data captured by user interface 150 within the new record, associates the new record with the uploaded multimedia stored within technical service repository 46 and updates index data 42B.

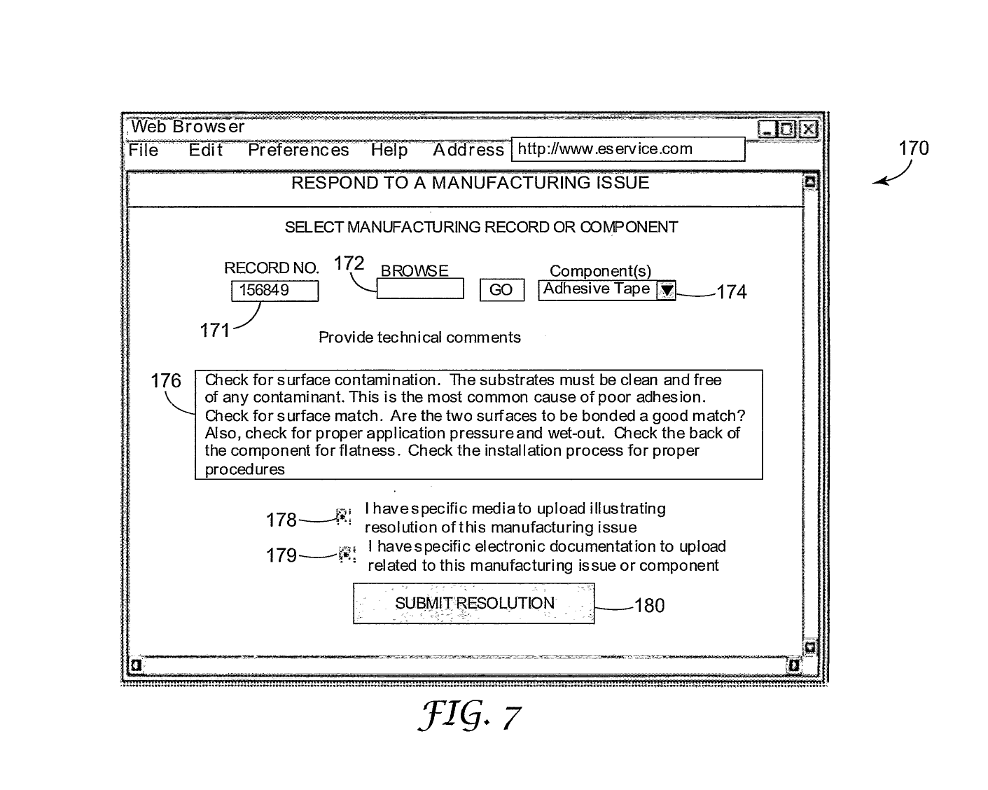

FIG. 7 illustrates an exemplary user interface 170 presented by service technician interface module 54 of TSD system 4 when the service technician responds to a recorded manufacturing issue. User interface 170 includes an input mechanism 171 by which the service technician specifies a record number associated with the manufacturing issue being addressed. Alternatively, input mechanism 172 allows the service technician to browse for a manufacturing issue based on keyword, e.g., name of a manufacturing plant, component, or equipment. Input mechanism 174 is a drop-down menu of components, and allows the service technician to select a component independent of a specific manufacturing issue.

Once a record number or a component is selected, the service technician may provide general technical service comments via input 176.

User interface 170 provides a checkbox 178 by which the service technician indicates whether specific multimedia has been captured that illustrates the resolution of the experienced manufacturing issue. In addition, user interface provides checkbox 179 by which the service technician indicates whether specific electronic technical service information, such as electronic documentation or functional specifications, is to be uploaded to technical service media repository 46. When the service technician selects SUBMIT RESOLUTION button 180, TSD system 4 selectively prompts the service technician to upload the specific multimedia and/or documentation based on checkboxes 178 and 179, and stores the multimedia and documentation within technical service repository 46 (FIG. 3). TSD system 4 associates the data captured by user interface 150 with the selected issue record or component, associates the data with the uploaded multimedia stored within technical service repository 46, and updates index data 42B for future reference. During or after this process, TSD system 4 may stream the uploaded multimedia to one or more automotive manufacturers, and provide an environment for real-time interaction between the service technician and the automotive manufacturers.

Various embodiments of the invention have been described. Although described in reference to automotive products, the techniques may be readily applied for delivery of technical service for other semi-finished goods that are used in an assembly process to produce final products. For example, the techniques may be applied to transportation industry generally, aerospace, consumer electronics and other industries in which technical service is provided to manufacturers or intermediate suppliers that utilize semi-finished goods. These and other embodiments are within the scope of the following claims.

1. A computer-based system for delivery of technical service for automotive components, the system comprising:
a customer interface module for network-based communication with a client device associated with a manufacturer of an automotive product;
a service technician interface module for network-based communication with a client device associated with a service technician associated with a supplier of a component utilized by the manufacturer to produce the automotive product; and
a technical service media repository that stores electronic technical service information related to the utilization of the component in the automotive product,
wherein the service technician interface module presents an interface by which the service technician uploads electronic technical service information to the technical service media repository, and
wherein the customer interface module presents an interface by which user associated with the manufacturer remotely accesses the technical service information, and selectively retrieves the technical service information based on a specific manufacturing issue experienced by manufacturer.

2. The system of claim 1, wherein the interface presented by the service technician interface module includes an input mechanism by which the service technician assigns the uploaded electronic technical service information to specific manufacturing issues experienced by manufacturer.

3. The system of claim 2, further comprising a database that stores location and identification information for technical service information,
wherein the database indexes the technical service information according to manufacturing issues assigned by the service technician.

4. The system of claim 1, further comprising:
a media capture module to receive from the client device associated with the manufacturer uploaded audio and video data related to a specific manufacturing issue experienced by the manufacturer; and
a streaming media module that streams the uploaded multi-media content to the client device associated with a service technician to present the audio and video data to the service technician for troubleshooting the specific manufacturing issue experienced by the manufacturer.

5. The system of claim 4, wherein the media capture module stores the uploaded audio and video data in the technical service media repository for subsequent streaming to the client device associated with the service technician.

6. The system of claim 1, further comprising:
a media capture module to receive from the client device associated with the service technician uploaded audio and video data related to a specific manufacturing issue experienced by the manufacturer; and
a streaming media module that streams the uploaded multi-media content to the client device associated with the manufacturer to present the audio and video data to instruct the manufacturer to resolve the specific manufacturing issue experienced by the manufacturer.

7. The system of claim 6, wherein the media capture module stores the upload audio and video data in the technical service media repository for subsequent streaming to the client device associated with the manufacturer.

8. The system of claim 1, further comprising an access control module that provides secure access to the technical service information.

9. The system of claim 1, wherein the technical service information includes audio and video data.

10. The system of claim 1, further comprising at least one web server and at least one application server that provide a computing environment for execution of the service technician interface module and the customer interface module.

11. The system of claim 1, further comprising at least one file server and at least one database server that provide a computing environment for the technical service media repository.

12. The system of claim 1, wherein the system is coupled to a network for communication with the client devices.

13. The system of claim 12, wherein the network comprises a public network or a private network.

14. The system of claim 1, further comprising an application programming interface (API) for providing the ability to establish direct connections with an external computing system that automatically records a manufacturing issue with the system.

15. The system of claim 14, wherein the API automatically receives from the external computing system one or more manufacturing records that describe the manufacturing issue.

16. The system of claim 15, wherein the manufacturing records provide run-time information for a manufacturing error.

17. A method for delivery of technical service for automotive components, the method comprising:
presenting a service technician interface by which a service technician associated with a supplier of a component uploads electronic technical service information related to utilization of the component in an automotive product;
storing the electronic technical service information in a network repository; and
presenting a customer interface by which a manufacturer of the automotive product remotely accesses the technical service information and selectively retrieves the technical service information based on specific manufacturing issues experienced by manufacturer.

18. The method of claim 17, further comprising:
presenting the service technician interface to include an input mechanism by which the service technician assigns the uploaded electronic technical service information to specific manufacturing issues experienced by manufacturer;
indexing the technical service information in the network repository according to manufacturing issues assigned by the service technician; and
presenting the customer interface to include an input mechanism by which the manufacturer selectively retrieves the technical service information based on the manufacturing issues assigned to the technical service information by the service technician.

19. The method of claim 17, further comprising:
receiving with a media capture module audio and video data uploaded from the client device associated with the manufacturer and related to a specific manufacturing issue experienced by the manufacturer; and
streaming the uploaded multi-media content to the client device associated with a service technician with a streaming media module to present the audio and video data to the service technician for troubleshooting the specific manufacturing issue experienced by the manufacturer.

20. The method of claim 19, further comprising storing the uploaded audio and video data in the technical service media repository for subsequent streaming to the client device associated with the service technician.

21. The method of claim 17, further comprising:
receiving with a media capture module audio and video data uploaded from the client device associated with the service technician and related to a specific manufacturing issue experienced by the manufacturer; and
streaming the uploaded multi-media content to the client device associated with a manufacturer with a streaming media module to present the audio and video data to the manufacturer data to instruct the manufacturer in addressing the specific manufacturing issue experienced by the manufacturer.

22. The method of claim 21, further comprising storing the uploaded audio and video data in the technical service media repository for subsequent streaming to the client device associated with the manufacturer.

23. The method of claim 17, further comprising executing a service technician interface module and a customer interface module on a computing environment provided by at least one web server and at least one application server to present the service technician interface and the customer interface.

24. The method of claim 17, wherein presenting a service technician interface and presenting a customer interface comprises communicating the service technician interface and the customer interface to the client devices over a public network or a private network.

25. A computer-readable medium comprising instructions for causing a programmable processor to:
present a service technician interface by which a service technician associated with a supplier of a component uploads electronic technical service information related to utilization of the component in an automotive product;
store the electronic technical service information in a network repository;
index the technical service information in the network repository according to manufacturing issues experienced by the manufacturer; and
present a customer interface by which a user associated with a manufacturer of the automotive product remotely accesses the technical service information and selectively retrieves the technical service information according to the manufacturing issues.
